(19) United States
(12) Patent Application Publication
(10) Pub. No.: US 2022/0166297 A1
(43) Pub. Date: May 26, 2022

(54) MOTOR AND ASSEMBLING METHOD OF MOTOR ROTOR STRUCTURE

(71) Applicant: CHICONY POWER TECHNOLOGY CO., LTD., New Taipei City (TW)

(72) Inventors: Chih-Ming HUANG, New Taipei City (TW); Chih-Ching YEH, New Taipei City (TW)

(21) Appl. No.: 17/190,203

(22) Filed: Mar. 2, 2021

(30) Foreign Application Priority Data
Nov. 20, 2020 (TW) 109140881

(51) Int. Cl. H02K 15/10; H02K 5/08; H02K 1/27; H02K 15/03

(52) U.S. Cl. CPC H02K 15/10; H02K 15/03; H02K 1/274; H02K 5/08

(57) ABSTRACT

A motor and an assembling method of a motor rotor structure are disclosed. The motor includes a stator, a rotor, an insulating assembly, and a shaft. The rotor includes a main body and magnetic members. The main body has an outer surface, a channel and two end surfaces. The channel runs through the two end surfaces so the main body is in a shape of annular column. The end surfaces are connected to the outer surface. The magnetic members are disposed on the outer surface. The insulating assembly is connected to the end surfaces. The insulating assembly has positioning portions. Each magnetic member is located between two adjacent positioning portions, and the magnetic members can be positioned on the outer surface through the positioning portions. The shaft passes through the insulating assembly and the channel, and connects to the main body through the insulating assembly.

### CROSS REFERENCE TO RELATED APPLICATIONS

This Non-provisional application claims priority under 35 U.S.C. § 119(a) on Patent Application No(s). 109140881 filed in Taiwan, Republic of China on Nov. 20, 2020, the entire contents of which are hereby incorporated by reference.

### BACKGROUND

### Technology Field

The present disclosure relates to a motor and, in particular, to an inner rotor motor and an assembling method of the rotor structure thereof.

### Description of Related Art

The motor is a device capable of converting electrical energy into mechanical energy, and it has been widely used in daily life products, such as air conditioners, fans, washing machines, water pumps, disk drives, electric razors, etc. Although there are many types of motors, the main application principle is still the electromagnetic effect. Generally speaking, the motor includes structures such as a rotor magnet and a stator coil, and is roughly divided into two types, the outer rotor motor and the inner rotor motor, according to their arrangement relationship. Taking the inner rotor motor as an example, when the current enters the stator coil, the generated magnetic field interacts with the magnetic field of the permanent magnet of the rotor, which can cause the shaft to rotate and enable the machine.

In the assembling procedure of the conventional inner rotor motor, the permanent magnets are fixed on the rotor body through jigs and gluing. However, it takes time for solidifying the glue, and the jig is removed after fixing the permanent magnets on the rotor body. Therefore, before the glue is totally solidified, the displacement of the permanent magnets may occur due to the collision during the removal of the jig, or due to the environmental vibration, or any other factors, resulting in non-equal intervals between the permanent magnets. Thus, the magnetic field between the permanent magnets and the stator coil is not uniform, which will cause a large deviation of the rotating rotor and a higher impact on the bearing due to vibration. Accordingly, the motor will be easily damaged during long-term operation. In addition, when the shaft and the rotor are not insulated from each other, the internal structures of the motor will form a current loop. Therefore, the current is likely generated and flowing through the shaft when the motor is running, which will damage the bearing, cause the poor performance of the motor, and eventually lead to motor failure.

### SUMMARY

This disclosure is to provide a motor having better characteristics (e.g. less jitters).

This disclosure is to provide a motor and an assembling method of a motor rotor structure that can prevent the generation of the current loop in the internal structures, thereby ensuring the normal operation of the bearing and increase the lifetime of the motor.

This disclosure is to provide a motor that can be easily assembled and can increase the stability and reliability of the motor during operation.

To achieve the above, a motor of this disclosure comprises a stator, a rotor, an insulating assembly, and a shaft. The rotor is disposed corresponding to the stator and comprises a main body and a plurality of magnetic members. The main body has an outer surface, two end surfaces and a channel. The channel runs through the two end surfaces, so that the main body is in a shape of annular column. The end surfaces are located at opposite sides of the main body and connected to the outer surface. The magnetic members are disposed around the outer surface of the main body. The insulating assembly is connected to the end surfaces of the main body, and has a plurality of positioning portions. Each of the magnetic members is located between adjacent two of the positioning portions, and the magnetic members are positioned on the outer surface of the main body through the positioning portions. The shaft passes through the insulating assembly and the channel of the main body, and the shaft is connected to the main body through the insulating assembly.

To achieve the above, an assembling method of a motor rotor structure of this disclosure comprises the following steps of: providing a main body, wherein the main body has a channel and two end surfaces, the channel runs through the main body, so that the main body is in a shape of annular column, and the end surfaces are located at opposite sides of the main body; providing an insulating assembly, wherein the insulating assembly is connected to the end surfaces of the main body, and the insulating assembly has a plurality of positioning portions disposed at a periphery of the insulating assembly; providing a plurality of magnetic members, wherein the magnetic members are located between adjacent two of the positioning portions, wherein the magnetic members are positioned at an outer surface of the main body through the positioning portions; and passing a shaft through the insulating assembly and the channel of the main body, wherein the shaft is connected to the main body through the insulating assembly.

In one embodiment, in a direction perpendicular to a long axis direction of the shaft, an inner diameter of the channel of the main body is greater than a diameter of the shaft.

In one embodiment, the insulating assembly has a through hole, and the insulating assembly is tightly fitted to the shaft through the through hole.

In one embodiment, the insulating assembly comprises two fixing members, the fixing members are located at the opposite sides of the main body, respectively, each of the fixing members has a side surface facing the corresponding end surface of the main body, and the side surface of each of the fixing members is connected to the corresponding end surface of the main body.

In one embodiment, in a direction parallel to a long axis direction of the shaft, the end surfaces of the main body have a first distance therebetween, the side surfaces of the fixing members have a second distance therebetween, and the first distance is substantially equal to the second distance.

In one embodiment, an annular hollow portion is formed between the main body and the shaft, and in a direction parallel to a long axis direction of the shaft, a width of the annular hollow portion is substantially equal to a distance between the side surfaces of the fixing members.

In one embodiment, the side surface of at least one of the fixing members has a first engaging structure, and the corresponding end surface of the main body has a second engaging structure corresponding to the first engaging structure.

In one embodiment, at least one of the fixing members is locked to the corresponding end surface of the main body through a locking member.

In one embodiment, the insulating assembly further comprises two connecting portions, each of the connecting portions is connected to a periphery of the corresponding fixing member, and the positioning portions are connected to the connecting portions.

In one embodiment, the fixing members, the connecting portions and the positioning portions are integrally formed as a single unit.

In one embodiment, each of the positioning portions of the insulating assembly covers a part of surfaces of adjacent two of the magnetic members away from the main body.

In one embodiment, the side surface of at least one of the fixing members has a protruding portion, the corresponding end surface of the main body has a recess portion corresponding to the protruding portion, and the assembling method further comprises a step of: inserting the protruding portion into the recess portion.

In one embodiment, the assembling method further comprises a step of: locking at least one of the fixing members to the corresponding end surface of the main body through a locking member.

As mentioned above, in the motor and the assembling method of the motor rotor structure of this disclosure, the insulating assembly is connected to the end surfaces of the main body, and each magnetic member is located between adjacent two of the positioning portions. Accordingly, the magnetic members can be positioned on the outer surface of the main body through the positioning portions, thereby arranging the magnetic members on the outer surface of the main body with equal intervals. Since the magnetic members are restricted on the outer surface of the main body, no displacements of the magnetic members on the outer surface of the main body is generated. Accordingly, the motor can have better characteristics (e.g. less jitters).

In addition, since the positioning portions of the insulating assembly can function as the jigs of the conventional art, the assembling procedure of this disclosure can be performed without preparing the jigs, thereby saving the manufacturing cost. Moreover, the insulating assembly is not removed, so that the magnetic members can be permanently restricted on the rotor body so as to prevent the displacement of the magnetic members regardless of any factors. Accordingly, the intervals of the magnetic members can be remained the same, thereby ensuring that the magnetic field between the magnetic members and the stator winding is uniform, and thus improving the stability and reliability of the motor during operation.

Furthermore, the insulating assembly of this disclosure can exactly position the shaft in the center of the rotor, so that the motor rotor structure can be easily assembled. In addition, because an annular hollow portion is formed between the rotor and the shaft, the insulating assembly can further exactly isolate the shaft and the rotor body while supporting the shaft. Accordingly, the internal structures of the motor will not form a current loop, so the AC voltage and current will not be formed on the shaft, thereby ensuring the normal operation of the bearing and increasing the lifetime of the motor.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing a motor according to an embodiment of this disclosure;

FIG. 1B is a schematic diagram showing an assembled motor rotor structure of FIG. 1A;

FIG. 1C is an exploded view of the motor rotor structure of FIG. 1B;

FIG. 1D is an exploded view of a part of the motor rotor structure of FIG. 1B;

FIG. 1E is a sectional view of the motor rotor structure of FIG. 1B along the line A-A;

FIGS. 2 and 3 are schematic diagrams showing the motor rotor structures according to different embodiments of this disclosure;

FIG. 4A is a schematic diagram showing the assembled motor rotor structure according to different embodiments of this disclosure;

FIG. 4B is a sectional view of the motor rotor structure of FIG. 4A along the line B-B;

FIG. 4C is a perspective sectional view of the motor rotor structure of FIG. 4A; and

FIG. 5 is a flow chart of an assembling method of a motor rotor structure of this disclosure.

### DETAILED DESCRIPTION OF THE DISCLOSURE

The present disclosure will be apparent from the following detailed description, which proceeds with reference to the accompanying drawings, wherein the same references relate to the same elements.

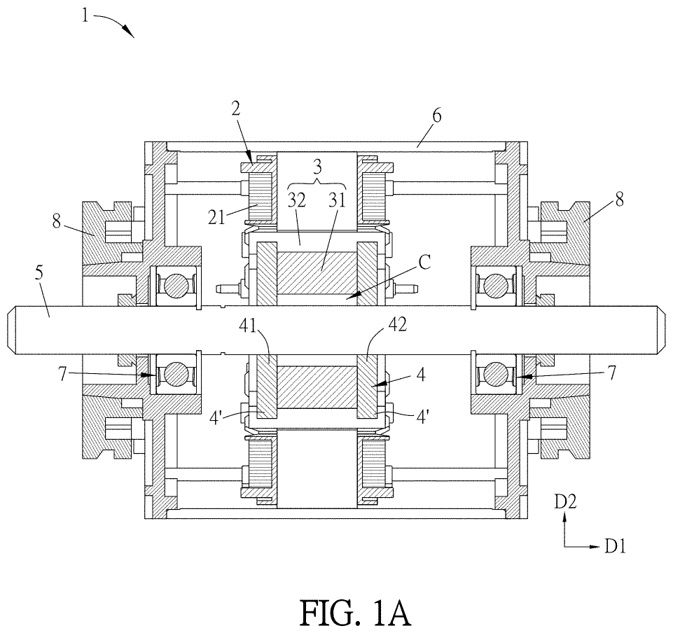

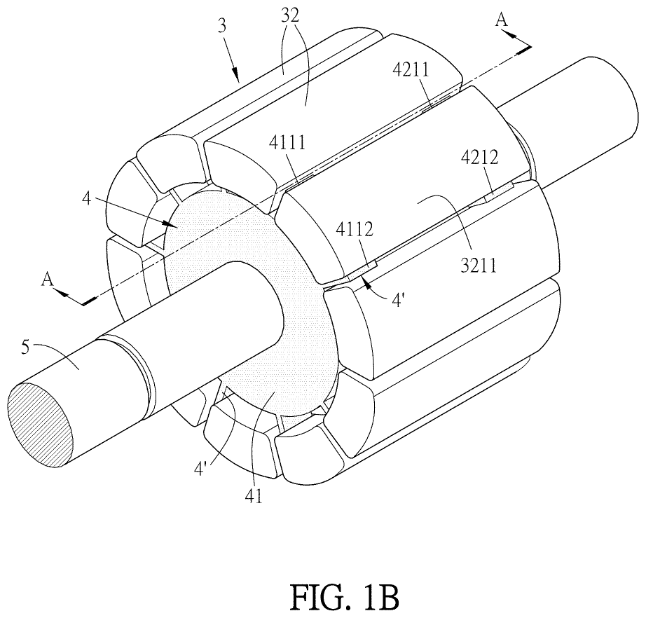

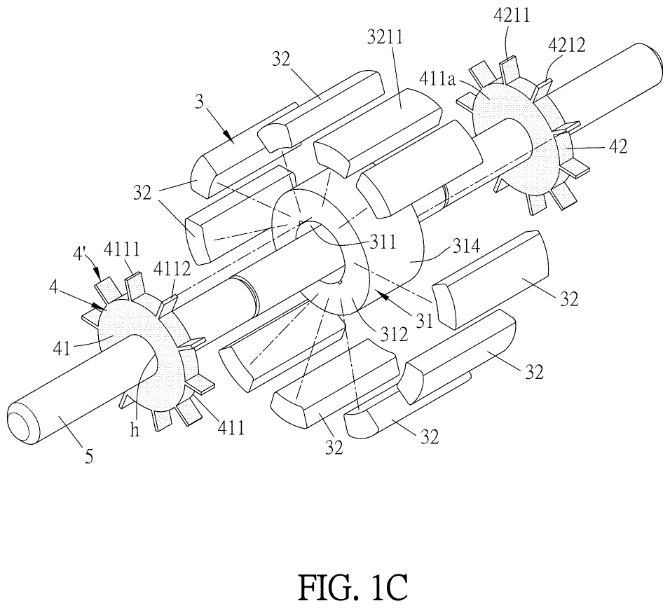

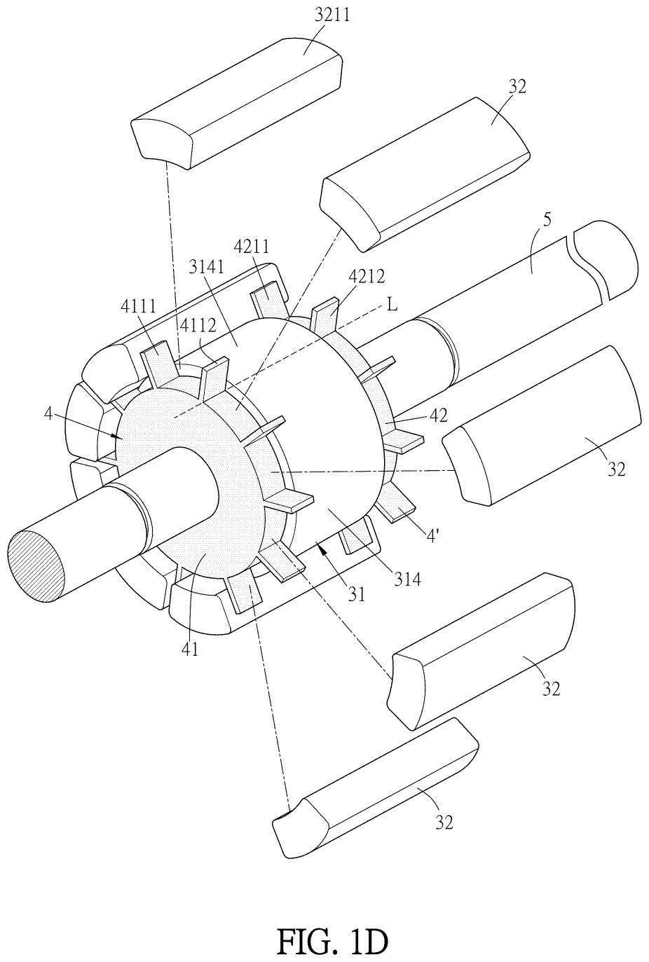

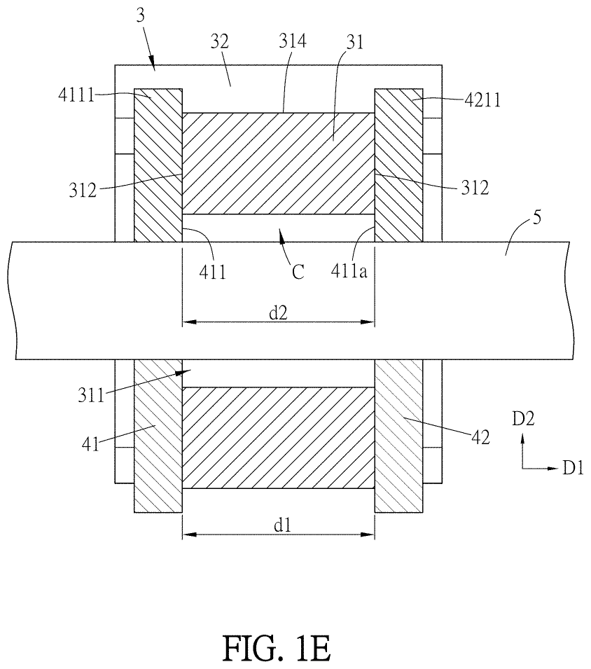

FIG. 1A is a schematic diagram showing a motor according to an embodiment of this disclosure, FIG. 1B is a schematic diagram showing an assembled motor rotor structure of FIG. 1A, FIG. 1C is an exploded view of the motor rotor structure of FIG. 1B, FIG. 1D is an exploded view of a part of the motor rotor structure of FIG. 1B, and FIG. 1E is a sectional view of the motor rotor structure of FIG. 1B along the line A-A.

As shown in FIGS. 1A to 1E, the motor 1 of this disclosure is an inner rotor motor and comprises a stator 2, a rotor 3, an insulating assembly 4, and a shaft 5. Moreover, the motor 1 of this embodiment can further comprise a housing 6, two bearings 7, and two external covers 8. Referring to FIG. 1B, the rotor 3, the insulating assembly 4, and the shaft 5 are assembled to define a motor rotor structure.

The stator 2 comprises a plurality of windings 21, which wind in an annular shape, and the windings 21 are disposed inside the housing 6 (see FIG. 1A).

The rotor 3 is disposed at the center of the annular stator 2 and is located corresponding to the stator 2. A gap is formed between the rotor 3 and the stator 2. The rotor 3 comprises a main body 31 and a plurality of magnetic members 32. When the magnetic field of the stator 2, which is induced by applying the current to the windings 21 of the stator 2, interacts with the magnetic field of the magnetic members 32 of the rotor 3, the motor rotor structure can be driven to rotate with respect to the stator 2. In this embodiment, the main body 31 is a rotor core, which has an outer surface 314, a channel 311 and two end surfaces 312 (see FIG. 1C). The channel 311 is formed at the center of the main body 31 and runs through the two end surfaces 312, so that the main body 31 is in a shape of annular column. The end surfaces 312 are located at opposite sides of the main body 31 and connected to the outer surface 314 (see FIG. 1E). In addition, the magnetic members can be permanent magnets and are disposed around the outer surface 314 of the main body 31.

The insulating assembly 4 is connected to the end surfaces 312 of the main body 31. In this embodiment, the insulating assembly 4 has a plurality of positioning portions 4′, and each of the magnetic members 32 is located between two adjacent positioning portions 4′. The magnetic members 32 are positioned on the outer surface 314 of the main body 31 through the positioning portions 4′. For example, referring to FIGS. 1B and 1C, the positioning portions 4′ comprise a first positioning portion 4111, a second positioning portion 4112, a third positioning portion 4211, and a fourth positioning portion 4212. In this case, the first positioning portion 4111 is disposed adjacent to the second positioning portion 4112, and the third positioning portion 4211 is disposed adjacent to the fourth positioning portion 4212. The magnetic members 32 comprise a first magnetic member 3211. One end of the first magnetic member 3211 is disposed between the first positioning portion 4111 and the second positioning portion 4112, and the other end of the first magnetic member 3211 is disposed between the third positioning portion 4211 and the fourth positioning portion 4212. Accordingly, the first magnetic member 3211 can be positioned on the outer surface 314 of the main body 31. To be noted, the configurations of other positioning portions can refer to the above example. In other words, the adjacent positioning portions 4′ can provide the positioning function for precisely positioning the magnetic members 32 on the main body 31, and the magnetic members 32 can be restricted at the desired positions without generating displacements.

As shown in FIGS. 1C and 1D, the insulating assembly 4 of this embodiment comprises a first fixing member 41 and a second fixing member 42, which have the same structure and are correspondingly disposed at two opposite sides of the main body 31, respectively. The first fixing member 41 has a side surface 411 facing one end surface 312 of the main body 31, and the second fixing member 42 has a side surface 411a facing the other end surface 312 of the main body 31. When the first fixing member 41 and the second fixing member 42 connect to the main body 31, the side surface 411 of the first fixing member 41 is connected to the corresponding end surface 312 of the main body 31, and the side surface 411a of the second fixing member 42 is connected to the corresponding end surface 312 of the main body 31. In some embodiments, the side surfaces 411 and 411a can be connected to the two end surfaces 312 of the main body 31 by, for example, adhesion or any other connecting methods, thereby installing the first fixing member 41 and the second fixing member 42 on opposite sides of the main body 31. Afterwards, the positioning portions 4′ can be provided to position the magnetic members 32. As shown in FIG. 1E, in the direction parallel to the long axis direction D1 of the shaft 5, the end surfaces 312 of the main body 31 have a first distance d1 therebetween, and the side surface 411 of the first fixing member 41 and the side surface 411a of the second fixing member 42 have a second distance d2 therebetween. The first distance d1 is substantially equal to the second distance d2. In other words, the first fixing member 41 and the second fixing member 42 are tightly fitted (attached) to the corresponding end surfaces 312 of the main body 31, respectively.

In addition, the peripheries of the first fixing member 41 and the second fixing member 42 are configured with a plurality of positioning portions 4′, which are arranged with equal intervals, wherein the distance between adjacent two positioning portions 4′ is equal to the width of the magnetic member 32, and the positioning portion 4′ on the first fixing member 41 and the corresponding positioning portion 4′ on the second fixing member 42 are located on the same extending line. In other words, the positioning portions 4′ on the first fixing member 41 and the positioning portions 4′ on the second fixing member 42 are arranged symmetrically one by one with respect to the main body 31. For example, the first positioning portion 4111 of the first fixing member 41 and the third positioning portion 4211 of the second fixing member 42 are located on the same extending line (not shown), and the second positioning portion 4112 of the first fixing member 41 and the fourth positioning portion 4212 of the second fixing member 42 are located on the other extending line L (see FIG. 1D). That is, the first positioning portion 4111 is arranged symmetric to the third positioning portion 4211, and the second positioning portion 4112 is arranged symmetric to the fourth positioning portion 4212. The other positioning portions are arranged in the same manner. Every two adjacent positioning portions 4′ of the first fixing member 41 and the corresponding (symmetrically arranged) two adjacent positioning portions 4′ of the second fixing member 42 can together define one restriction area for restricting the corresponding magnetic member 32 therein without generating displacement.

For example, as shown in FIGS. 1C and 1D, the first positioning portion 4111, the second positioning portion 4112, the third positioning portion 4211 and the fourth positioning portion 4212 can together define a restriction area 3141 on the outer surface 314. That is, every two adjacent positioning portions of the first fixing member 41 and the corresponding (symmetrically arranged) two adjacent positioning portions of the second fixing member 42 can together define the restriction area 3141 on the outer surface 314, wherein the distance between the first positioning portion 4111 and the second positioning portion 4112 is equal to the width of the first magnetic member 3211, and the distance between the third positioning portion 4211 and the fourth positioning portion 4212 is equal to the width of the first magnetic member 3211. Accordingly, the first magnetic member 3211 can be disposed and restricted in the restriction area 3141 of the outer surface 314 without generating displacement. The other positioning portions are arranged in the same manner.

In other words, the plural positioning portions 4′ are arranged with equal intervals, so that the magnetic members 32 can be also arranged on the outer surface 314 of the main body 31 with equal intervals. That is, the intervals of the magnetic members 32 are all the same, wherein the intervals are defined by the thicknesses of the positioning portions 4′ in the direction perpendicular to the long axis direction of the shaft 5. Accordingly, the magnetic field of the magnetic members 32 of the rotor 3 can uniformly interact with the magnetic field of the windings 21 of the stator 2, thereby enhancing the stability and reliability of the operation of the motor 1. In this embodiment, the first fixing member 41 and the second fixing member 42 are insulating components, which can be integrally formed as one piece with using the material including, for example but not limited to, plastics, rubber, or resin, or can be formed by coating an insulating material (e.g. plastics, rubber, or resin) on a metal.

The shaft 5 passes through the insulating assembly 4 and the channel 311 of the main body 31, and the shaft 5 is connected to the main body 31 through the insulating assembly 4. As shown in FIG. 1C, the shaft 5 of this embodiment passes through the first fixing member 41, the channel 311 of the main body 31, and the second fixing member 42 in order, so that the rotor 3 is disposed between the first fixing member 41 and the second fixing member 42. In this embodiment, each of the first fixing member 41 and the second fixing member 42 has a through hole h, and the shaft 5 passes through the through holes h. Moreover, the first fixing member 41 and the second fixing member 42 can be tightly fitted to the shaft 5 through the through holes h. Herein, the term “tightly fitted” means that the diameter of the shaft 5 is substantially equal to the inner diameters of the through holes h of the first fixing member 41 and the second fixing member 42. Accordingly, the shaft 5 can be tightly fitted to the first fixing member 41 and the second fixing member 42, and they cannot be relatively rotated with respect to each other.

In addition, with reference to FIG. 1E, in a direction D2 perpendicular to the long axis direction D1 of the shaft 5, an inner diameter of the channel 311 of the main body 31 is greater than a diameter of the shaft 5. In other words, the shaft 5 passes through the channel 311 of the main body 31 without contacting the inner wall of the channel 311, so that an annular hollow portion C can be formed between the shaft 5 and the inner wall of the channel 311. Accordingly, the shaft 5 and the main body 31 is indirectly connected to each other via the insulating assembly 4 (including the first fixing member 41 and the second fixing member 42) instead of directly connecting to each other. When the rotor 3 rotates with relative to the stator 2, the rotor 3 can drive the shaft 5 to rotate through the insulating assembly 4. In addition, in a direction parallel to the long axis direction D1 of the shaft 5, a width of the annular hollow portion C is substantially equal to a distance between the side surface 411 of the fixing member 41 and the side surface 411a of the fixing member 42. To be noted, the width of the annular hollow portion C is also substantially equal to a distance between the two end surfaces 312 of the main body 31. This design can prevent the first fixing member 41 and the second fixing member 42 from entering the channel 311 of the main body 31.

Referring to FIG. 1A, the two external covers 8 correspondingly cover the two opposite sides of the housing 6 and are individually tightly fitted to the bearings 7. The bearings 7 are disposed on the covers 8 and located at two opposite sides of the rotor 3, respectively. In addition, the bearings 7 are tightly fitted to the shaft 5.

As mentioned above, in the motor 1 of this embodiment, the insulating assembly 4, which includes the first fixing member 41 and the second fixing member 42, is connected to the main body 31 and the end surfaces 312, and each magnetic member 32 is disposed between two adjacent positioning portions 4′, thereby positioning the magnetic members 32 on the outer surface 314 of the main body 31 through the positioning portions 4′. Accordingly, the magnetic members 32 can be disposed on the outer surface 314 of the main body 31 with equal intervals. Since the magnetic members 32 can be disposed on the outer surface 314 of the main body 31 precisely with equal intervals, the motor 1 can have better characteristics. For example, the interaction between the magnetic field generated by the windings 21 of the stator 2 and the magnetic field of the rotor 3 can be more uniform, so that when the motor 1 operates in high-speed rotation, a deviation of the rotating rotor structure can be minimized and have less jitters, thereby increasing the lifetime of the motor 1.

In the conventional motor, due to the factors such as the non-uniform arrangement of the windings of the stator and the magnetic members of the rotor, and/or the non-uniform gaps between the windings of the stator and the magnetic members of the rotor and between the stator and the rotor, the shaft will inevitably rotate in an incompletely symmetrical magnetic field, so that an AC voltage may be generated at both ends of the shaft, thereby generating an AC current. The partial discharge of the AC current will generate high temperature, which may melt parts of the inner groove, the outer groove, and balls of the bearing, thereby forming recesses at many tiny areas in the bearing. These recesses can cause noise and vibration when the motor rotates, and can even cause the bearing to fail so as to damage the motor.

In the motor 1 of this embodiment, the insulating assembly 4, which includes the first fixing member 41 and the second fixing member 42, is connected to the end surfaces 312 of the main body 31, the shaft 5 is connected to the main body 31 through the insulating assembly 4, and the annular hollow portion C is formed between the shaft 5 and the main body 31. Thus, the shaft 5 can be exactly positioned at the center of the rotor 3, and the insulating assembly 4 can support the shaft 5 and exactly isolate the shaft 5 and the main body 31 of the rotor 3 (the annular hollow portion C is formed therebetween). Accordingly, the current loop is not generated in the internal structures of the motor 1, and the AC voltage and AC current are not formed at two ends of the shaft 5, thereby ensuring the normal operation of the bearing 7 and thus increasing the lifetime of the motor 1.

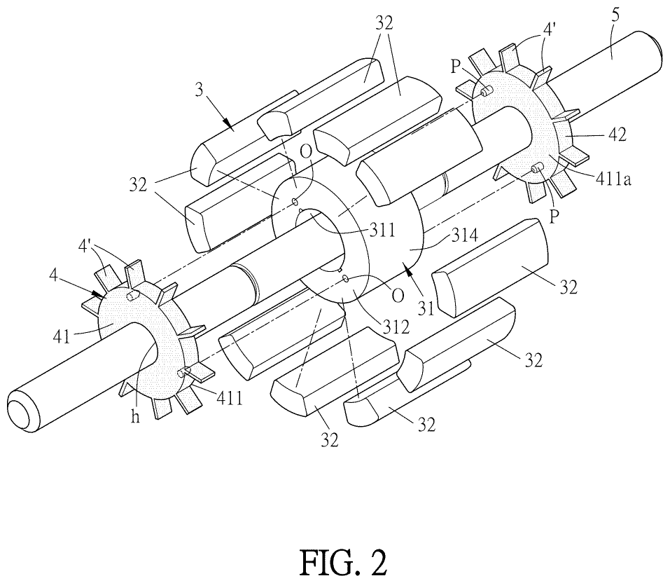

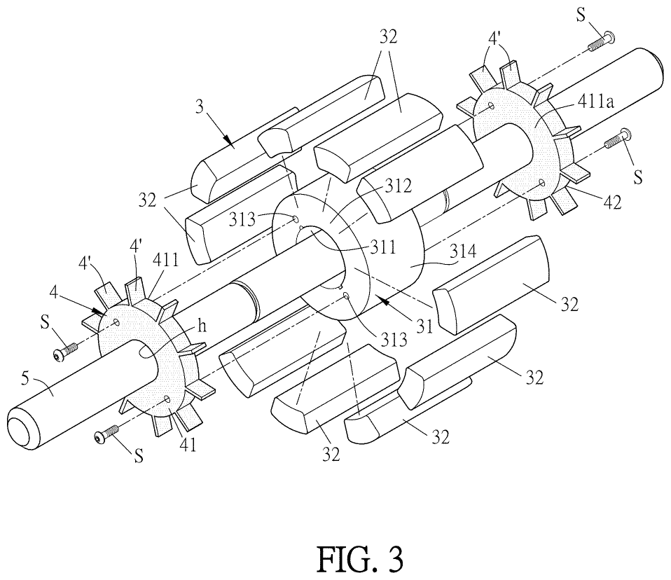

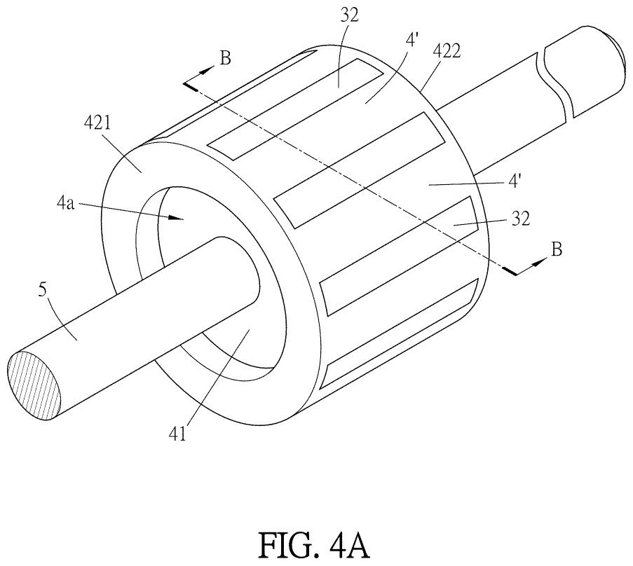

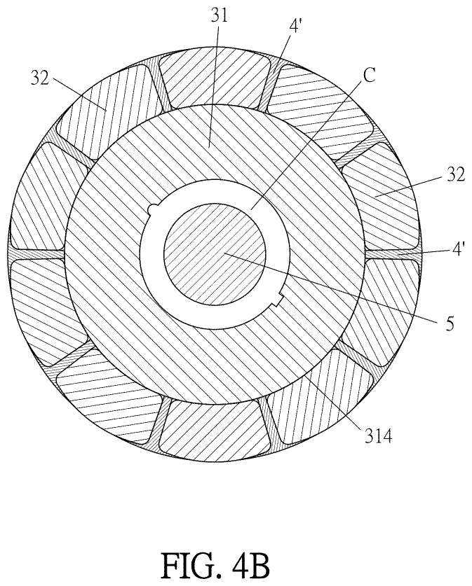

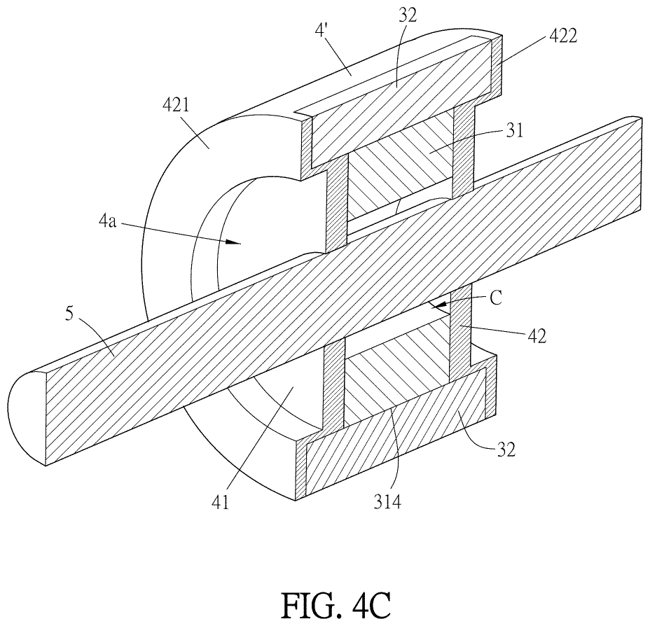

FIGS. 2 and 3 are schematic diagrams showing the motor rotor structures according to different embodiments of this disclosure, FIG. 4A is a schematic diagram showing the assembled motor rotor structure according to different embodiments of this disclosure, FIG. 4B is a sectional view of the motor rotor structure of FIG. 4A along the line B-B, and FIG. 4C is a perspective sectional view of the motor rotor structure of FIG. 4A.

As shown in FIG. 2, the configurations and connections of the components of the motor rotor structure of this embodiment are mostly the same as those of the motor rotor structure of the previous embodiment. Different from the previous embodiment, in the motor rotor structure of this embodiment, each of the side surface 411 of the first fixing member 41 and the side surface 411a of the second fixing member 42 comprises at least one first engaging structure, and each of the end surfaces 312 of the main body 31 comprises a second engaging structure, which corresponds to the first engaging structure. In this embodiment, the first engaging structure is a protruding portion P, and the second engaging structure is a recess portion O. When assembling the main body 31 with the first fixing member 41 or the second fixing member 42, the protruding portion P is inserted into the recess portion O for connecting the first fixing member 41 or the second fixing member 42 to the main body 31. In this embodiment, each of the first fixing member 41 and the second fixing member 42 comprises two protruding portions P, which are configured to be inserted into two corresponding recess portions O. To be noted, the amounts of the first engaging structures and the second engaging structures are an example only, and the amounts thereof can be different in other embodiments. Besides, the configurations of the first engaging structure and the second engaging structure can be changed. For example, each of the side surface 411 of the first fixing member 41 and the side surface 411a of the second fixing member 42 comprises two recess portions O, and each of the end surfaces 312 of the main body 31 comprises two protruding portions P corresponding to the recess portions, respectively. This disclosure is not limited.

As shown in FIG. 3, the configurations and connections of the components of the motor rotor structure of this embodiment are mostly the same as those of the motor rotor structure of the previous embodiment. Different from the previous embodiment, the motor rotor structure of this embodiment further comprises at least one locking member S, which penetrates through the first fixing member 41 or the second fixing member 42, and each of the end surfaces 312 of the main body 31 is configured with a thread hole 313 corresponding to the locking member S. Accordingly, the first fixing member 41 and the second fixing member 42 can be locked on the end surfaces 312 of the main body 31, respectively, through the corresponding locking members S. In this embodiment, the motor rotor structure comprises four locking members S, wherein two locking members S penetrate through the first fixing member 41 and then connect to the corresponding end surface 312 of the main body 31, and the other two locking members S penetrate through the second fixing member 42 and then connect to the corresponding end surface 312 of the main body 31. In some embodiments, the locking member S can be, for example but not limited to, a screw or a bolt.

As shown in FIGS. 4A, 4B and 4C, the configurations and connections of the components of the motor rotor structure of this embodiment are mostly the same as those of the motor rotor structure of the previous embodiment. Different from the previous embodiment, in the motor rotor structure of this embodiment, the insulating assembly 4a further comprises, excepting the first fixing member 41 and the second fixing member, a first connecting portion 421 and a second connecting portion 422, which are disposed corresponding to the first fixing member 41 and the second fixing member 42, respectively. In this embodiment, each of the first connecting portion 421 and the second connecting portion 422 has an annular structure, and the first connecting portion 421 and the second connecting portion 422 are connected to the peripheries of the first fixing member 41 and the second fixing member 42, respectively. The fixing portions 4′ are connected to the first connecting portion 421 and the second connecting portion 422. In addition, the first connecting portion 421 and the second connecting portion 422 connect to the first fixing member 41 and the second fixing member 42, respectively, and the first connecting portion 421 and the second connecting portion 422 also cover the opposite side surfaces of the magnetic members 32. The positioning portions 4′ are correspondingly connected to the first connecting portion 421 and the second connecting portion 422, and cover all or a part of the surfaces of the magnetic members 32 away from the main body 31.

In this embodiment, the first fixing member 41, the second fixing member 42, the first connecting portion 421, the second connecting portion 422, the positioning portions 4′ disposed on the periphery of the first fixing member 41, and the positioning portions 4′ disposed on the periphery of the second fixing member 42, which together form the insulating assembly 4a, can be integrally formed as a single unit, but this disclosure is not limited thereto. In some embodiments, at least one of the first fixing member 41, the second fixing member 42, the first connecting portion 421, the second connecting portion 422, the positioning portions 4′ disposed on the periphery of the first fixing member 41, and the positioning portions 4′ disposed on the periphery of the second fixing member 42 can be an independent unit, the separated units or parts can be connected by, for example, adhesion, screwing, embedding, or the likes. In some embodiments, the positioning portions 4′ disposed on the periphery of the first fixing member 41 and the positioning portions 4′ disposed on the periphery of the second fixing member 42 can be not connected with each other, and this disclosure is not limited. In some embodiments, the insulating assembly 4a can be, for example but not limited to, a unit made by plastic injection molding.

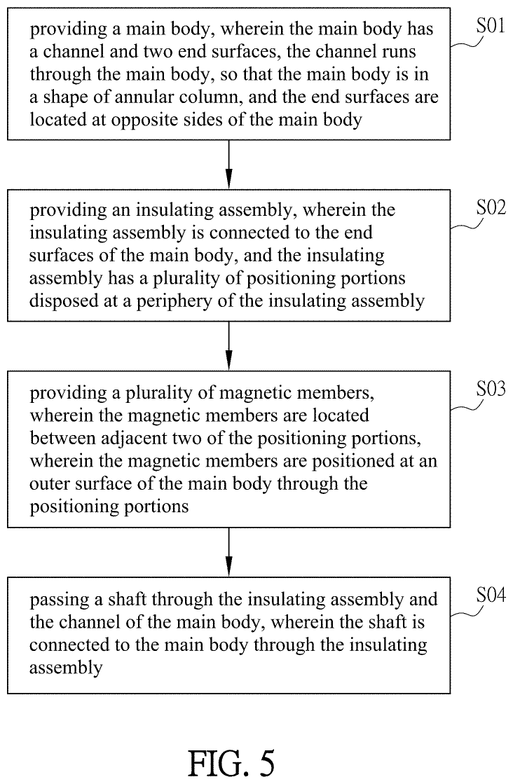

The assembling method of a motor rotor structure will be described hereinafter with reference to FIG. 5 in view of FIGS. 1A to 1E, wherein FIG. 5 is a flow chart of an assembling method of a motor rotor structure.

The assembling method of a motor rotor structure of this embodiment at least comprises the following steps S01 to S04.

The step S01 is to provide a main body 31, wherein the main body 31 has a channel 311 and two end surfaces 312, the channel 311 runs through the main body 31, so that the main body 31 is in a shape of annular column, and the end surfaces 312 are located at opposite sides of the main body 31.

The step S02 is to provide an insulating assembly 4, wherein the insulating assembly 4 is connected to the end surfaces 312 of the main body 31, and the insulating assembly 4 has a plurality of positioning portions 4′ disposed at a periphery of the insulating assembly 4. In this embodiment, the positioning portions 4′ at least comprise a first positioning portion 4111, a second positioning portion 4112, a third positioning portion 4211, and a fourth positioning portion 4212, and the insulating assembly 4 comprises a first fixing member 41 and a second fixing member 42. The first fixing member 41 has a side surface 411 facing one end surface 312 of the main body 31, and the second fixing member 42 has a side surface 411a facing the other end surface 312 of the main body 31. In addition, the assembling method further comprises steps of: disposing the first fixing member 41 and the second fixing member 42 at two opposite sides of the main body 31, respectively; and connecting the side surface 411 of the first fixing member 41 and the side surface 411a of the second fixing member 42 to the two end surfaces 312 of the main body 31, respectively. In this embodiment, the first positioning portion 4111 of the first fixing member 41 and the third positioning portion 4211 of the second fixing member 42 are located on the same extending line, and the second positioning portion 4112 of the first fixing member 41 and the fourth positioning portion 4212 of the second fixing member 42 are located on the other extending line L. The other positioning portions are arranged in the same manner. In addition, in the direction parallel to the long axis direction D1 of the shaft 5, the end surfaces 312 of the main body 31 have a first distance d1 therebetween, and the side surface 411 of the first fixing member 41 and the side surface 411a of the second fixing member 42 have a second distance d2 therebetween. The first distance d1 is substantially equal to the second distance d2. Furthermore, an annular hollow portion C is formed between the shaft 5 and the main body 31. In a direction parallel to the long axis direction D1 of the shaft 5, a width of the annular hollow portion C is substantially equal to a distance between the side surface 411 of the fixing member 41 and the side surface 411a of the fixing member 42.

The step S03 is to provide a plurality of magnetic members 32, wherein the magnetic members 32 are located between adjacent two of the positioning portions 4′, and the magnetic members 32 are positioned at an outer surface 314 of the main body 31 through the positioning portions 4′. In this embodiment, the magnetic members 32 comprise a first magnetic member 3211, which is positioned in the restriction area 3141 defined by the first positioning portion 4111, the second positioning portion 4112, the third positioning portion 4211 and the fourth positioning portion 4212, so that the first magnetic member 3211 can be disposed and restricted on the outer surface 314 of the main body 31 without generating displacement. The other positioning portions are arranged in the same manner. Accordingly, the magnetic member 32 can be exactly disposed on the outer surface 314 of the main body 31, so that the motor 1 can have better characteristics, thereby enhancing the stability and reliability of the operation of the motor 1.

The step S04 is to pass a shaft 5 through the insulating assembly 4 and the channel 311 of the main body 31, wherein the shaft 5 is connected to the main body 31 through the insulating assembly 4. In this embodiment, the insulating assembly 4, which includes the first fixing member 41 and the second fixing member 42, is tightly fitted to the shaft 5 through the through holes h thereof. In addition, in the direction D2 perpendicular to the long axis direction D1 of the shaft 5, an inner diameter of the channel 311 of the main body 31 is greater than a diameter of the shaft 5.

Accordingly, in this embodiment, the shaft 5 can be exactly positioned at the center of the rotor 3 based on the structural design and assembling procedure of the rotor 3, the shaft 5, and the insulating assembly 4 (including the first fixing member 41 and the second fixing member 42), and thus the assembling procedure of the rotor structure also becomes easier.

Referring to FIG. 2, in some embodiments, the assembling method can further comprises a step of: inserting the protruding portions P of the first fixing member 41 and the second fixing member 42 into the corresponding recess portions O of the main body 31. Herein, the side surface 411 of the first fixing member 41 and the side surface 411a of the second fixing member 42 are configured with the protruding portions P, the two end surfaces 312 of the main body 31 are configured with the recess portions O corresponding to the protruding portions P. After inserting the protruding portions P into the corresponding recess portions O, the first fixing member 41 and the second fixing member 42 can be connected to the main body 31.

Referring to FIG. 3, in some embodiments, the assembling method can further comprises a step of: locking the first fixing member 41 and the second fixing member 42 to the corresponding end surfaces 312 of the main body 31 through locking members S. Herein, the first fixing member 41 and the second fixing member 42 are locked to the corresponding end surfaces 312 of the main body 31 through a plurality of locking members S.

Referring to FIGS. 4A to 4C, in some embodiments, the insulating assembly 4a further comprises, excepting the first fixing member 41 and the second fixing member, a first connecting portion 421 and a second connecting portion 422, which are correspondingly connected to the peripheries of the first fixing member 41 and the second fixing member 42, respectively. The positioning portions 4′ are connected to the first connecting portion 421 and the second connecting portion 422. In some embodiments, each of the positioning portions 4′ of the insulating assembly 4a covers a part of surfaces of two adjacent magnetic members 32 away from the main body 31. In some embodiments, the first fixing member 41, the second fixing member 42, the first connecting portion 421, the second connecting portion 422, the positioning portions 4′ disposed on the periphery of the first fixing member 41, and the positioning portions 4′ disposed on the periphery of the second fixing member 42 can be integrally formed as a single unit (i.e. the insulating assembly 4a).

To be noted, the other technical features of the assembling method of the motor rotor structure can be referred to the above embodiments, so the detailed descriptions thereof will be omitted.

As mentioned above, in the motor and the assembling method of the motor rotor structure of this disclosure, the insulating assembly is connected to the end surfaces of the main body, and each magnetic member is located between adjacent two of the positioning portions. Accordingly, the magnetic members can be positioned on the outer surface of the main body through the positioning portions, thereby arranging the magnetic members on the outer surface of the main body with equal intervals. Since the magnetic members are restricted on the outer surface of the main body, no displacements of the magnetic members on the outer surface of the main body is generated. Accordingly, the motor can have better characteristics (e.g. less jitters).

In addition, since the positioning portions of the insulating assembly can function as the jigs of the conventional art, the conventional jig is not needed in the assembling procedure, thereby saving the manufacturing cost. Moreover, the insulating assembly is not removed, so that the magnetic members can be permanently restricted on the rotor body so as to prevent the displacement of the magnetic members regardless of any factors. In addition, any adjacent two of the magnetic members are separated by the positioning portion, so that the intervals of the magnetic members can be remained the same (equal to the thickness of the positioning portion), thereby ensuring that the magnetic field between the magnetic members and the stator winding is uniform, and thus improving the stability and reliability of the motor during operation.

Furthermore, the insulating assembly of this disclosure can exactly position the shaft in the center of the rotor, so that the motor rotor structure can be easily assembled. In addition, because an annular hollow portion is formed between the rotor and the shaft, the insulating assembly can further exactly isolate the shaft and the rotor body while supporting the shaft. Accordingly, the internal structures of the motor will not form a current loop, so the AC voltage and current will not be formed on the shaft, thereby ensuring the normal operation of the bearing and increasing the lifetime of the motor.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A motor, comprising:
a stator;
a rotor disposed corresponding to the stator and comprising:
a main body having:
an outer surface,
two end surfaces located at opposite sides of the main body and connected to the outer surface, and
a channel running through the two end surfaces, so that the main body is in a shape of annular column, and
a plurality of magnetic members disposed around the outer surface of the main body;
an insulating assembly connected to the end surfaces of the main body, wherein the insulating assembly has a plurality of positioning portions; and
a shaft passing through the insulating assembly and the channel of the main body, wherein the shaft is connected to the main body through the insulating assembly, each of the magnetic members is located between adjacent two of the positioning portions, and the magnetic members are positioned on the outer surface of the main body through the positioning portions.

2. The motor of claim 1, wherein the insulating assembly has a through hole, and the insulating assembly is tightly fitted to the shaft through the through hole.

3. The motor of claim 1, wherein in a direction perpendicular to a long axis direction of the shaft, an inner diameter of the channel of the main body is greater than a diameter of the shaft.

4. The motor of claim 1, wherein the insulating assembly comprises two fixing members, the fixing members are located at the opposite sides of the main body, respectively, each of the fixing members has a side surface facing the corresponding end surface of the main body, and the side surface of each of the fixing members is connected to the corresponding end surface of the main body.

5. The motor of claim 4, wherein in a direction parallel to a long axis direction of the shaft, the end surfaces of the main body have a first distance therebetween, the side surfaces of the fixing members have a second distance therebetween, and the first distance is substantially equal to the second distance.

6. The motor of claim 4, wherein an annular hollow portion is formed between the main body and the shaft, and in a direction parallel to a long axis direction of the shaft, a width of the annular hollow portion is substantially equal to a distance between the side surfaces of the fixing members.

7. The motor of claim 4, wherein the side surface of at least one of the fixing members has a first engaging structure, and the corresponding end surface of the main body has a second engaging structure corresponding to the first engaging structure.

8. The motor of claim 4, wherein at least one of the fixing members is locked to the corresponding end surface of the main body through a locking member.

9. The motor of claim 4, wherein the insulating assembly further comprises two connecting portions, each of the connecting portions is connected to a periphery of the corresponding fixing member, the positioning portions are connected to the connecting portions, and the fixing members, the connecting portions and the positioning portions are integrally formed as a single unit.

10. The motor of claim 9, wherein each of the positioning portions of the insulating assembly covers a part of surfaces of adjacent two of the magnetic members away from the main body.

11. An assembling method of a motor rotor structure, comprising steps of:
providing a main body, wherein the main body has a channel and two end surfaces, the channel runs through the main body, so that the main body is in a shape of annular column, and the end surfaces are located at opposite sides of the main body;
providing an insulating assembly, wherein the insulating assembly is connected to the end surfaces of the main body, and the insulating assembly has a plurality of positioning portions disposed at a periphery of the insulating assembly;
providing a plurality of magnetic members, wherein the magnetic members are located between adjacent two of the positioning portions, and the magnetic members are positioned at an outer surface of the main body through the positioning portions; and
passing a shaft through the insulating assembly and the channel of the main body, wherein the shaft is connected to the main body through the insulating assembly.

12. The assembling method of claim 11, wherein the insulating assembly has a through hole, and the insulating assembly is tightly fitted to the shaft through the through hole.

13. The assembling method of claim 11, wherein in a direction perpendicular to a long axis direction of the shaft, an inner diameter of the channel of the main body is greater than a diameter of the shaft.

14. The assembling method of claim 11, wherein the insulating assembly comprises two fixing members, the fixing members are located at the opposite sides of the main body, respectively, each of the fixing members has a side surface facing the corresponding end surface of the main body, and the side surface of each of the fixing members is connected to the corresponding end surface of the main body.

15. The assembling method of claim 14, wherein in a direction parallel to a long axis direction of the shaft, the end surfaces of the main body have a first distance therebetween, the side surfaces of the fixing members have a second distance therebetween, and the first distance is substantially equal to the second distance.

16. The assembling method of claim 14, wherein an annular hollow portion is formed between the main body and the shaft, and in a direction parallel to a long axis direction of the shaft, a width of the annular hollow portion is substantially equal to a distance between the side surfaces of the fixing members.

17. The assembling method of claim 14, wherein the side surface of at least one of the fixing members has a protruding portion, and the corresponding end surface of the main body has a recess portion corresponding to the protruding portion, the assembling method further comprising:
inserting the protruding portion into the recess portion.

18. The assembling method of claim 14, further comprising:
locking at least one of the fixing members to the corresponding end surface of the main body through a locking member.

19. The assembling method of claim 14, wherein the insulating assembly further comprises two connecting portions, each of the connecting portions is connected to a periphery of the corresponding fixing member, the positioning portions are connected to the connecting portions, and the fixing members, the connecting portions and the positioning portions are integrally formed as a single unit.

20. The assembling method of claim 19, wherein each of the positioning portions of the insulating assembly covers a part of surfaces of adjacent two of the magnetic members away from the main body.
